(19) United States
(12) Patent Application Publication
(10) Pub. No.: US 2010/0291343 A1
(43) Pub. Date: Nov. 18, 2010

(54) METHOD FOR MANUFACTURING PERFORATED NONWOVEN FABRICS

(75) Inventor: Rinaldo BOCCHIO, Pollone (IT)

Correspondence Address: SCULLY SCOTT MURPHY & PRESSER, PC, 400 GARDEN CITY PLAZA, SUITE 300, GARDEN CITY, NY, 11530, US

(73) Assignee: Union Industries S.p.A., Masserano (IT)

(21) Appl. No.: 12/809,766

(22) PCT Filed: Dec. 23, 2008
(86) PCT No.: PCT/EP2008/068255

§ 371 Date: Jun. 21, 2010

(30) Foreign Application Priority Data
Dec. 28, 2007 (IT) MI2007A002444

(51) Int. Cl. B32B 3/10; B29C 67/00

(52) U.S. Cl. 428/131; 264/154

(57) ABSTRACT

A method for manufacturing a perforated laminated or nonwoven fabric, comprising the steps of:

preheating the laminated or nonwoven fabric to such a temperature as to allow softening without deformations or melting of the nonwoven fabric;

forming a plurality of three-dimensional open craters within the laminated or nonwoven fabric, by deforming the laminated or nonwoven fabric, without breaking fibers or filaments of the nonwoven fabric;

cooling the laminated or nonwoven fabric so as to maintain the deformation of fibers or filaments in order to define permanently the open three-dimensional craters.

### TECHNICAL FIELD

The present invention relates to a method for manufacturing perforated nonwoven fabrics.

More particularly, the invention relates to a method for manufacturing individual or laminated nonwoven fabrics with three-dimensional conical openings.

### BACKGROUND ART

As is known, nonwoven fabrics made for example of polypropylene, with holes provided in the nonwoven fabric as a consequence of an embossing process, are commercially available.

However, known methods are unable to provide an open three-dimensional crater, since generally the nonwoven fabric is made to pass over a roller that is provided with spikes and against which a contrast roller is pressed so that the spikes pierce the nonwoven fabric. The spikes may be heated in order to melt the fibers and thus consolidate a hole in the nonwoven fabric exactly where the spike perforates the nonwoven fabric, thereby melting or breaking the filaments.

The provision of through holes in a nonwoven fabric entails the fact that the tactile feel provided by the nonwoven fabric is certainly not the desired one of “volume” and softness, since the holes formed in the nonwoven fabric tend to “flatten” the product and deprive it of “three-dimensionality”.

### DISCLOSURE OF THE INVENTION

The aim of the present invention is to devise a method for providing permanently three-dimensional perforated nonwoven fabrics in which the hole is not formed by breaking the fibers of the nonwoven fabric.

Within this aim, an object of the present invention is to provide a method for providing perforated nonwoven fabrics in which the fibers of the nonwoven fabric assume the desired shape, so as to have a nonwoven fabric with three-dimensional craters without breakage of the nonwoven fabric at the craters.

Another object of the present invention is to provide a method for providing a perforated nonwoven fabric in which the hole is formed by deformation of the fibers of the nonwoven fabric, so as to obtain a three-dimensionality of the region at the crater formed by the deformation of the fibers of the nonwoven fabric.

Another object of the present invention is to provide a method for providing a perforated nonwoven fabric that is highly reliable.

This aim, as well as these and other objects that will become better apparent hereinafter, are achieved by a method for manufacturing a three-dimensional perforated laminated or nonwoven fabric, characterized in that it comprises the steps of:

preheating the laminated or nonwoven fabric to such a temperature as to allow softening without deformations or melting of the nonwoven fabric;

forming a plurality of open three-dimensional craters within the laminated or nonwoven fabric, by deforming the laminated or nonwoven fabric, without breaking the fibers or filaments of said nonwoven fabric;

cooling said laminated or nonwoven fabric so as to maintain said deformation of fibers or filaments in order to define permanently said open three-dimensional craters.

### BRIEF DESCRIPTION OF THE DRAWINGS

Further characteristics and advantages of the present invention will become better apparent from the description of a preferred but not exclusive embodiment of the method according to the present invention, illustrated in the accompanying drawings, wherein:

FIG. 1 is a side elevation view of an open crater provided by means of the method according to the present invention;

FIG. 2 is a top plan view of the crater of FIG. 1;

FIG. 3 is a schematic view of a machine adapted to perform the method of the present invention;

FIG. 4 is a schematic view of a detail of the machine of FIG. 3, in a first operating step;

FIG. 5 is a schematic view of a detail of the machine of FIG. 3, in a second operating step.

### WAYS OF CARRYING OUT THE INVENTION

The method according to the present invention allows to provide three-dimensional craters 1 on a nonwoven fabric 2 by relying on a displacement of the fibers by means of hot needles and by utilizing the thermoplastic characteristic of nonwoven fabrics made of synthetic fibers.

Substantially, the hole or aperture 1 is defined by a deformation of the fibers of the nonwoven fabric 2 such as to create a three-dimensional crater 1, which therefore allows to give a thickness effect to the nonwoven fabric 2 provided with such craters.

The preheated filaments, by adapting to the particular shape of the heated needle, constitute the walls of the open three-dimensional crater 1.

The nonwoven fabric 2 is processed on a machine 10 that is equipped with a roller 11 provided with spikes 12 which are perfectly aligned with a perforated contrast roller 13, which has holes 14 on its side wall that are shaped like the crater to be provided on the nonwoven fabric 2.

In order to facilitate the process for softening the nonwoven fabric 2, such fabric is heated by a suitable roller 15 before perforation.

The penetration of the spikes 12 or teeth of the roller 11 in the nonwoven fabric 2 causes a displacement of the fibers at the affected area and their conveyance into the corresponding hole 14 formed in the perforated contrast roller 13 so as to constitute the walls of the three-dimensional crater 1.

However, the temperature to which the spikes 12 of the roller 11 are heated is such as to allow the deformation of the fibers of the nonwoven fabric without however entailing the breakage/melting of the fibers or of the filaments.

The fibers thus assume the desired shape, and a system for cooling immediately after release of the nonwoven fabric 2 from the roller 11 and contrast roller 13 fixes its consistency, preventing the fibers from returning to their original non-deformed condition.

Therefore, the method according to the present invention is characterized by the following steps.

First of all, the nonwoven fabric 2 is heated to such a temperature as to allow softening of the nonwoven fabric 2. This step occurs by means of the passage between a hot smooth roller 15, at a temperature that varies according to the composition of the nonwoven fabric. For example, for nonwoven fabrics 2 based on polypropylene, this temperature can range from 130° C. to 140° C.

In this first step, the film of nonwoven fabric 2 begins a softening step without however undergoing deformations or melting.

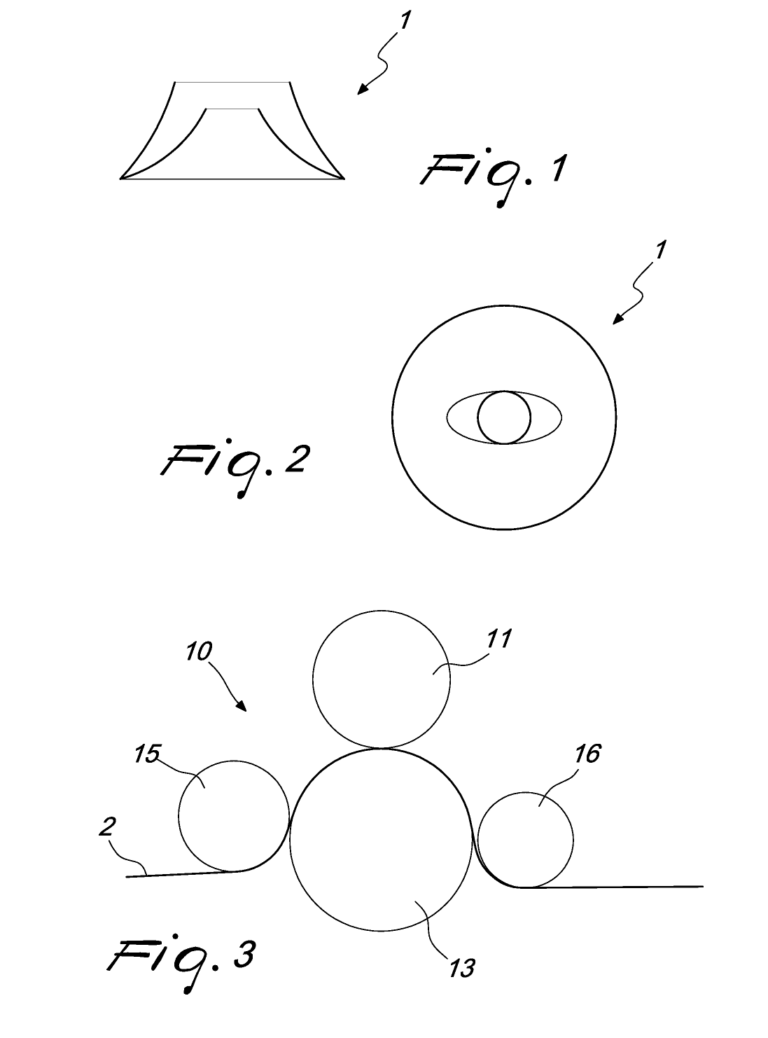

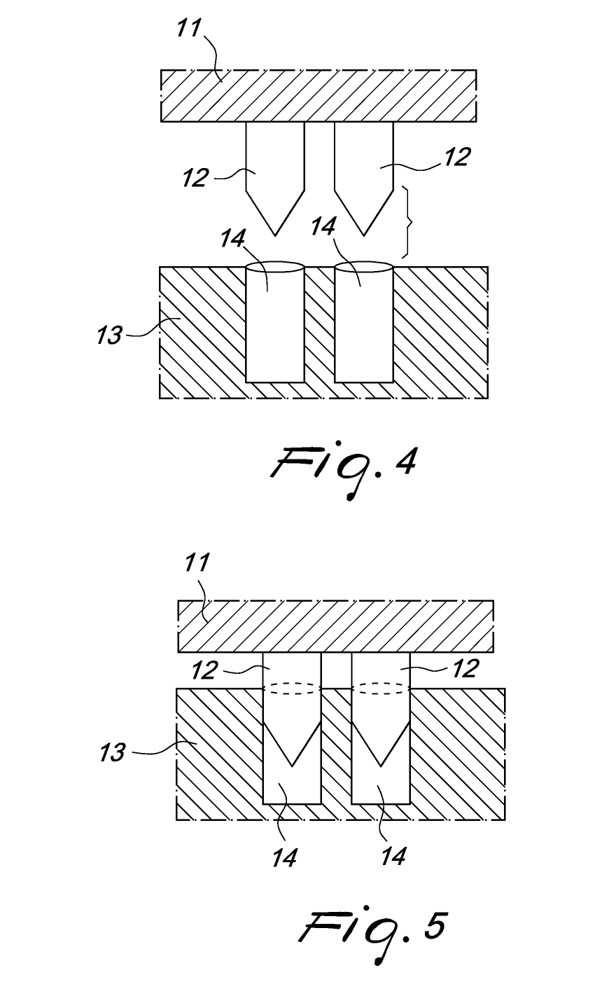

The softened nonwoven fabric 2 is then passed between the roller 11 provided with heated needles or spikes 12 and the contrast roller 13, which also is heated and is provided with corresponding holes 14 that allow deformation of the nonwoven fabric 2, the laminated or nonwoven fabric being pushed by the needles or spikes 12 so as to cover the wall of the female contrast roller 13, adapting within the holes 14 of the contrast roller 13, thus forming a three-dimensional conical structure 1, as shown in FIG. 1.

The extent of the interpenetration between the male roller, i.e., the roller 11 provided with spikes or needles 12, and the contrast roller 13, i.e., the roller provided with holes 14, can be adjusted in order to determine the depth of the cone and therefore the three-dimensionality of the opening.

The laminated or nonwoven fabric 2, thanks to the first preheating step, is not torn during this step of interpenetration of the spikes of the male roller in the holes of the female roller.

The temperature of the needles or spikes 12 allows a further softening of the filaments or fibers that constitute the nonwoven fabric 2 and therefore allows a total deformation of the structure without however reaching the melting of the material.

The temperature, therefore, can be variable depending on the type of laminated or nonwoven fabric, but in any case must be, as mentioned, such as to not allow the melting of the material, and ranges for example from 150° C. to 160° C. for a nonwoven fabric based on polypropylene.

After the step of forming the craters 1 by interpenetration of the spikes or needles 12 of the male roller 11 within the holes 14 of the complementary female contrast roller 13, the laminated or nonwoven fabric, with the craters formed, is cooled by passing over a cold smooth roller 16.

This sudden cooling ensures that the conical open structure 1 of the nonwoven fabric 2 as a consequence of the deformation obtained by means of the heated needles or spikes 12 is maintained over time.

The steps described occur in a continuous process, and in particular the preheating step is a fundamental step to allow not to break filaments of the fibers of the subsequent crater opening step.

Moreover, the preheating step allows the heated needles or spikes 12 to use the transmission of heat to the nonwoven fabric 2, allowing a controlled softening thereof that is suitable to deform the nonwoven fabric 2 without creating tearing or plasticizing or melting thereof.

Subsequent rapid cooling of the nonwoven fabric 2 ensures that the formed open craters 1 maintain their three-dimensional shape, without a memory effect for the previous shape, i.e., the non-deformed shape.

In practice it has been found that the method according to the present invention fully achieves the intended aim and objects, since it allows to form open craters in a nonwoven fabric, determined by the deformation of the fibers or filaments, without breaking them. Therefore, the formed open craters contribute to determine a three-dimensionality of the nonwoven fabric, by being permanent and open deformations of the nonwoven fabric but not simple holes formed in the fabric.

Therefore, the nonwoven fabric or laminated fabric with open craters provided by means of the method according to the present invention allows a greater three-dimensionality than can be offered by a similar laminated nonwoven fabric provided with conventional through holes. This three-dimensionality ensures a higher liquid crossing speed, a reduced return of liquids and greater softness with respect to conventional perforated nonwoven fabrics.

The method thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. MI2007A002444 from which this application claims priority are incorporated herein by reference.

1-6. (canceled)

7. A method for manufacturing a three-dimensional perforated laminated or nonwoven fabric, comprising the steps of:
preheating the laminated or nonwoven fabric to such a temperature as to allow softening without deformations or melting of the nonwoven fabric;
forming a plurality of three-dimensional open craters within the laminated or nonwoven fabric, by deforming the laminated or nonwoven fabric, without breaking fibers or filaments of said nonwoven fabric;
cooling said laminated or nonwoven fabric so as to maintain said deformation of fibers or filaments in order to define permanently said open three-dimensional craters.

8. The method according to claim 7, wherein said step of forming said craters comprises passing said nonwoven fabric or laminated fabric through a roller provided with heated spikes and a corresponding contrast roller provided with holes for the interpenetration of said spikes in said holes.

9. The method according to claim 8, wherein said spikes of said roller are heated to such a temperature as to allow further softening of said filaments or fibers and allow a total deformation of said laminated or nonwoven fabric without reaching the melting of said laminated or nonwoven fabric.

10. The method according to claim 7, wherein said cooling step occurs by passing the laminated or nonwoven fabric over a cold smooth roller.

11. The method according to claim 8, wherein said contrast roller is heated.

11. The method according to claim 8, wherein said contrast roller is heated.

12. A laminated or nonwoven fabric, further comprising a plurality of open three-dimensional craters formed by the deformation of the fibers or filaments of said laminated or nonwoven fabric, said deformation being provided without breaking said filaments or fibers.
